(19) United States
(12) Patent Application Publication
(10) Pub. No.: US 2005/0173308 A1
(43) Pub. Date: Aug. 11, 2005

(54) Elutriated sluice

(76) Inventor: Christopher George Kelsey, RSD Willunga (AU)

Correspondence Address: NIXON & VANDERHYE, PC, 901 NORTH GLEBE ROAD, 11TH FLOOR, ARLINGTON, VA, 22203, US

(21) Appl. No.: 10/510,739

(22) PCT Filed: Apr. 14, 2003
(86) PCT No.: PCT/AU03/00445

(30) Foreign Application Priority Data
Apr. 12, 2002 (AU) PS 1728

(51) Int. Cl. B03D 1/00

(52) U.S. Cl. 209/155; 210/800

(57) ABSTRACT

There is provided a pinched sluice apparatus for classification of a feed particle mixture into two or more factions, including a pinched sluice with a sloping floor and a pair of convergent side walls forming a sluice channel which changes in cross-section from being shallow and wide at the inlet end to being deeper and narrower at the discharge end. Elutriation fluid is introduced through the floor and is passed through the bed, while the sluice is reciprocated to induce alternating up and down acceleration of the sluice channel relative to the settling force, such that classification is achieved by alternating differential acceleration and hindered settling of particles in the bed. A centrifugal version of the device is also disclosed.

### FIELD OF THE INVENTION

The invention relates to a pinched sluice apparatus and method for classification of a particle mixture feed into a plurality of fractions. The invention has application to the separation of an ore pulp into a concentrate and tailings fractions, but is not limited to such applications.

### BACKGROUND OF THE INVENTION

Historically, ore bodies have been relatively coarse grained, and in many cases have been easily separated by simple gravity devices, such as sluices, pinched sluices, cones, spirals, jigs, shaking tables, and many other devices and variations. Whilst these devices are still used in some form or other, there is a need for technologies which allow for improved product grades and which will be suitable for processing of finely ground ores or the finer-grained ore bodies now being worked.

A pinched sluice is a thick bed separation device having a downwardly sloping floor and opposed, convergent side walls forming a sluice channel which decreases in width but increases in depth from the inlet to the outlet. A feed pulp of mixed particles is fed as a relatively thin bed to the inlet end, and is transformed into a thick bed separated into light and heavy fractions as it flows through the device.

### SUMMARY OF THE INVENTION

The present invention aims to provide an improved pinched sluice apparatus and a method of particle separation using this apparatus.

The present invention thus provides an apparatus for classification of a feed particle mixture into two or more fractions by differential acceleration and settling under influence of a settling force, including
a pinched sluice having a sluice channel which changes in transverse cross sectional shape from a feed inlet end which is shallow in a direction parallel to the settling force and wide in a direction perpendicular to the settling force to a discharge end which is deeper and more narrow than the feed inlet end,
feed apparatus for distributing the feed mixture to the feed inlet end as a shallow bed, said bed increasing in depth as the bed travels through the sluice channel from said inlet end to said discharge end,
discharge apparatus for discharge of said two or more fractions from said deeper bed at said discharge end,
elutriation means for inducing a flow of elutriation fluid through the bed in a substantially direction opposite to the settling force as the bed travels through the sluice channel from said inlet end to said discharge end,
a reciprocating drive for inducing alternating up and down acceleration of the sluice channel relative to the settling force,
such that said alternating acceleration and elutriation together induce classification of said particle mixture by alternating acceleration and hindered settling of particles in the bed.

The present invention further provides a method for classification of a feed particle mixture into two or more fractions by differential acceleration and settling under influence of a settling force, including
providing a pinched sluice having a sluice channel which changes in transverse cross sectional shape from a feed inlet end which is shallow in a direction parallel to the settling force and wide in a direction perpendicular to the settling force to a discharge end which is deeper and more narrow than the feed inlet end,
distributing the feed mixture to the feed inlet end as a shallow bed and causing said bed to travel through the sluice channel from said inlet end to said discharge end, said bed increasing in depth from said inlet end to said discharge end,
discharging said two or more fractions from said deeper bed at said discharge end,
elutriating the bed by inducing a flow of elutriation fluid through the bed in a substantially direction opposite to the settling force as the bed travels through the sluice channel from said inlet end to said discharge end, and
reciprocating the bed by inducing alternating up and down acceleration of the sluice channel relative to the settling force,
such that said alternating acceleration and elutriation together induce classification of said particle mixture by alternating acceleration and hindered settling of particles in the bed.

Preferably, said sluice channel is formed by at least a floor and a pair of opposed side walls and wherein said elutriation means includes a plurality of elutriating fluid inlets in the floor of the sluice channel.

In one form of the apparatus, the settling force is gravity, with the sluice channel floor sloping downwards from said inlet end to said discharge end.

A further form of the apparatus is mounted for rotation about a rotational axis, such that the settling force is the apparent centrifugal force on the particles within the bed.

In this centrifugal form, the floor of the sluice channel is an outer circumferential wall of the sluice channel and the reciprocating drive causes alternating radially outwards and radially inwards acceleration of the sluice channel.

Preferably, the reciprocation of the sluice has a bottom-truncated sinusoidal wave form, comprising a downstroke of said wave form inducing said differential hindered settling and a truncation and upstroke of said wave form inducing said differential acceleration.

Preferably, an amplitude of the reciprocation of the sluice channel increases from said inlet end to said discharge end.

### BRIEF DESCRIPTION OF THE DRAWINGS

Further preferred embodiments of the invention will be described with reference to the accompanying drawings, in which:

FIG. 1 is a schematic plan view of a gravity sluice according to a first embodiment;

FIG. 2 is a schematic elevational cross-section of the sluice of FIG. 1 taken along the axis 2-2;

FIG. 3 is a more detailed elevational cross-section of the sluice channel and elutriation chamber arrangement;

FIGS. 4 and 5 are, respectively, plan and elevational views showing the reciprocating drive mechanism of the sluice;

FIG. 6 is a schematic elevation of an alternative reciprocation mechanism;

FIG. 7 illustrates the truncated sinusoidal wave jigging pattern of the sluice;

FIG. 8 is an elevational cross-section of a centrifugal sluice according to a second embodiment;

FIG. 9 is an elevational cross-section of a centrifugal sluice according to a third embodiment; and

FIG. 10 is a schematic perspective of abowl configuration of the centrifugal sluice of FIG. 9.

### DETAILED DESCRIPTION OF THE PREFERRED EMBODIMENTS

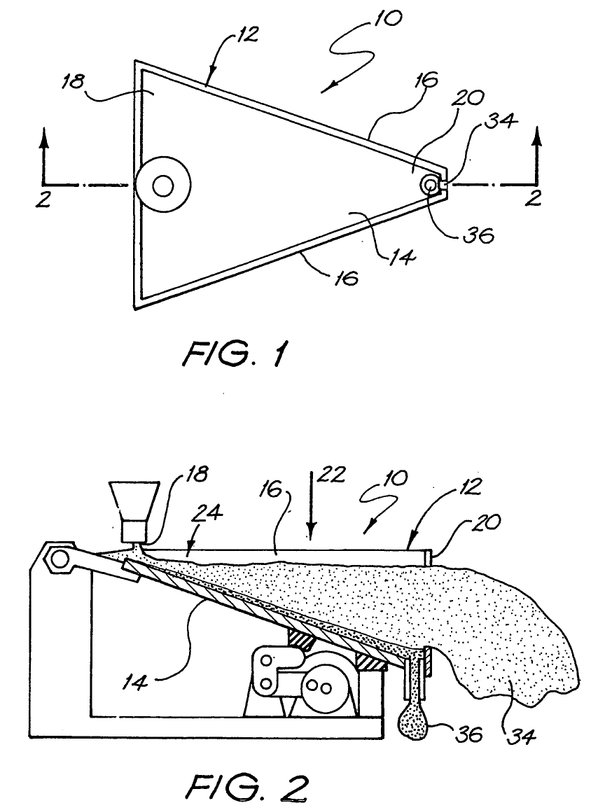

FIGS. 1 and 2 schematically illustrate a gravity sluice apparatus 10 according to a first embodiment of the invention.

A pinched sluice channel 12 of the apparatus comprises a floor 14 and a pair of convergent side walls 16. The floor 14 slopes downward from an inlet end 18 to the outlet 20, so that the cross-sectional shape of the channel decreases in width and increases in depth (relative to the direction of the gravity settling force 22) from the inlet end 18 to the outlet 20. Preferably the angles of inclination of the floor and of convergence of the side walls are chosen to result in an approximately constant cross-sectional area along the length of the sluice channel 12.

A feed pulp, consisting of a mixture of particles of different mass and/or density, is fed to the sluice inlet as a shallow bed 24. The cross-section of this bed becomes deeper and more narrow, following the cross-section of the sluice channel, as the pulp flows down the inclined floor toward the outlet end 20.

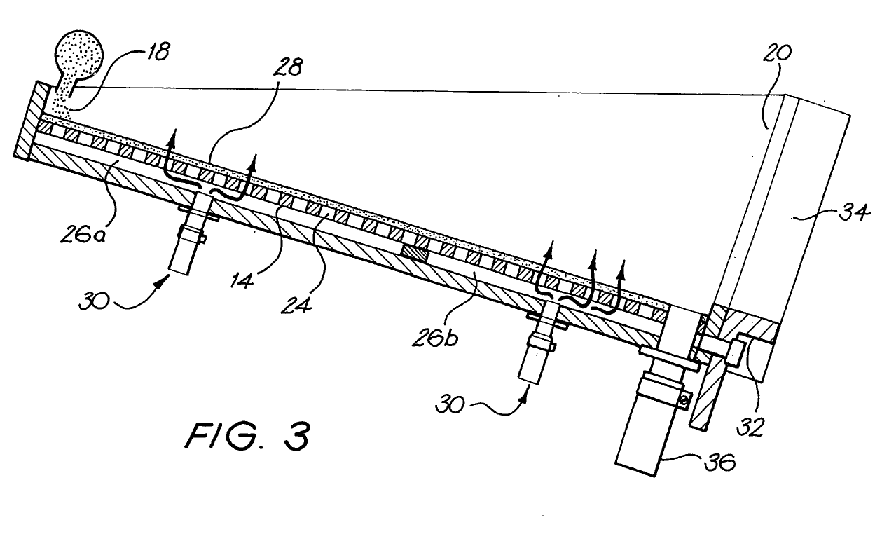

As shown in FIG. 3, the floor 14 of the channel is formed of punched plate or other suitable perforated material having elutriation perforations 24 communicating with an elutriation chamber 26 below the floor. The perforated plate is covered by a sheet 28 of heavy weight coarse weave canvas or fluid permeable woven plastics sheeting. The sheeting may be secured by rail fastening or other suitable fastening means.

An elutriation fluid, such as water or air, is fed under pressure to the chamber via fluid inlet 30, and passes through the perforations 24 and sheet 28 and upwards through the bed 24 to cause stratification of the pulp by differential hindered settling of the particles, carrying the light fractions to the top.

The elutriation chamber 26 may be divided into two or more zones, for example a lower pressure zone 26a and higher pressure zone 26b, with different elutriation fluid pressures depending on the thickness of the pulp bed in the sluice channel above that zone.

The outlet end 20 of the sluice has a splitter for separating the stratified pulp bed into fractions, and discharge outlets for the separated fractions. A suitable splitting and discharge arrangement is shown in FIG. 3, where a height-adjustable weir 32 splits the stratified bed into a light, fraction 34 which flows over the weir and discharges through the open end of the sluice channel and a heavies, fraction which is discharged through a concentrate discharge 36.

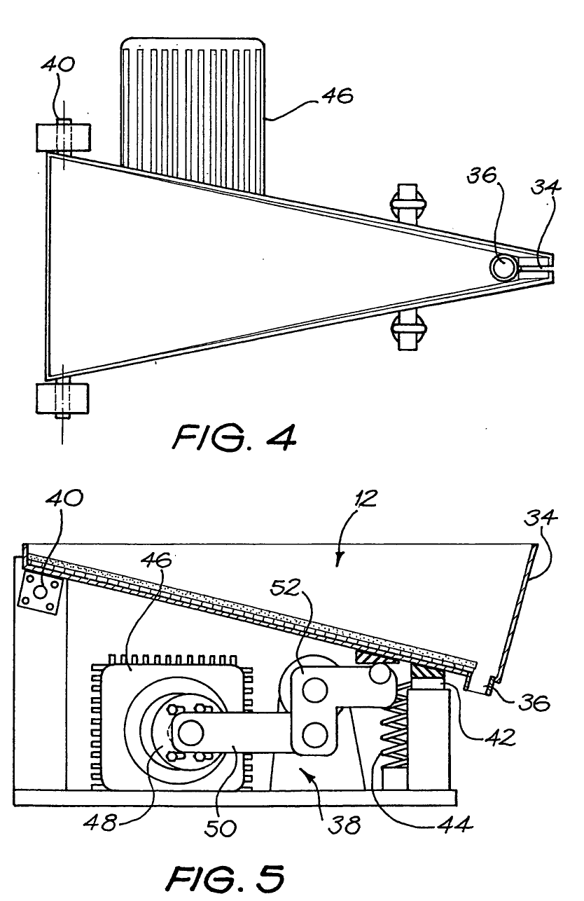

The sluice also has a reciprocating drive, generally designated 38 and discussed below with reference to FIGS. 4 to 7, which cooperates with the elutriation to cause efficient separation by alternating differential acceleration and hindered settling of the particles.

The sluice channel is mounted via a rubber mounted pivot 40 located adjacent the inlet end of the sluice, and the discharge end is urged downwards towards a bottoming block 42 by a strong tension spring 44.

The reciprocation drive 38 includes a motor 46 driving a crank with an adjustable eccentric 48, to which is connected a link 50 to an L-shaped pivoting cam 52 which drives up and down reciprocation of the sluice channel. The spring 44 urges the sluice against the cam.

By pivoting the sluice about a pivot point 40 located at the shallow inlet end, the amplitude of reciprocation of the sluice increases along the length of the sluice generally proportional to the depth of the bed.

The bottoming block 42 is positioned to limit the downstroke of the sluice movement, so that the reciprocation of the sluice follows a truncated sinusoidal wave form discussed below with reference to FIG. 7.

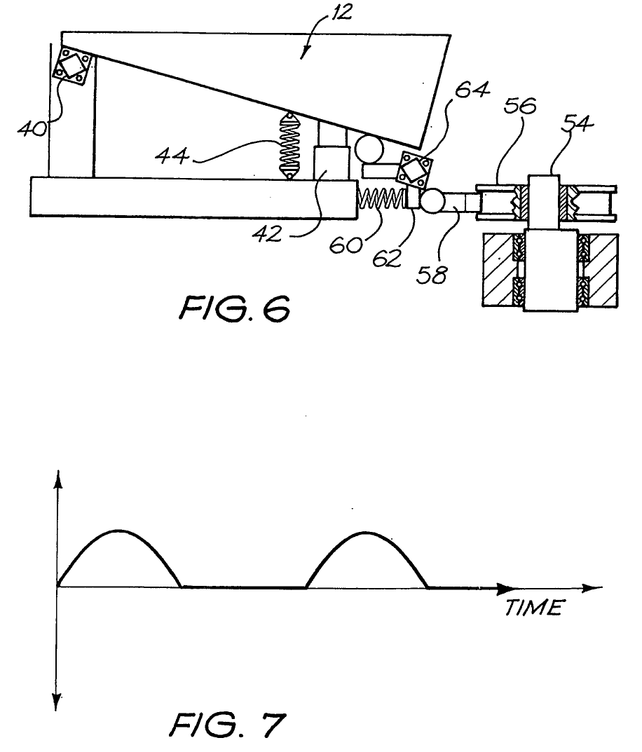

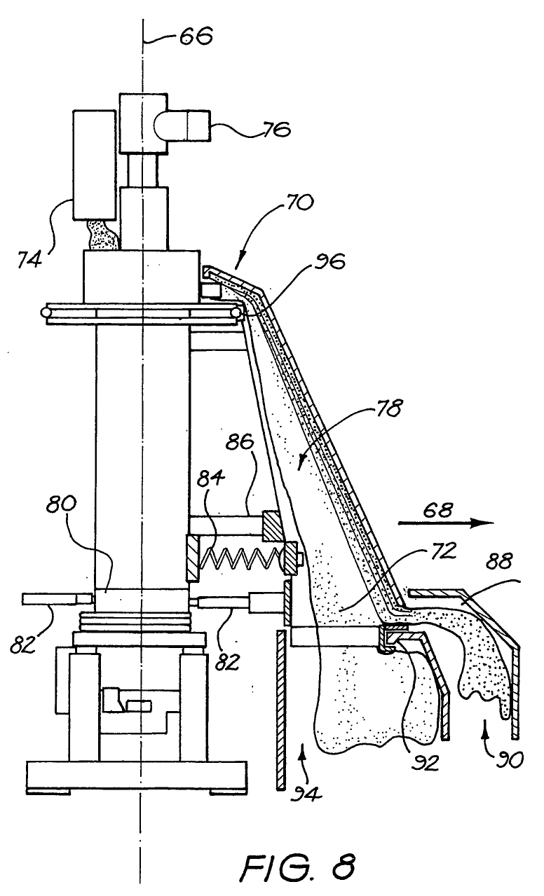

FIG. 6 shows an alternative configuration of the reciprocation mechanism suitable for driving multiple sluice units simultaneously. A central crank 54 has a follower 56 which drives a radial array of pushrods 58 leading to respective of a circular bank of sluices 12 (for ease of representation, only one sluice is shown). Each pushrod is biased toward the crank follower by means of a compression spring 60 or rubber element, and has at its end a tapered drive block 62 which engages with a surface of a rubber mounted pivot 64 to drive up and down reciprocation of the respective sluice as the crank rotates. The arrangement of multiple sluices around a central crank drive allows for balancing of forces through the crank.

The arrangement of FIG. 6 also includes a tension spring 44 or rubber for biasing the sluice down, and a bottoming block 42 for truncating the reciprocation as shown in FIG. 7.

With reference to FIG. 7, when the sluice reaches the apex of the wave and commences the downstroke under influence of the tension spring 44, the elutriation fluid is still flowing upwards and the pulp experiences differential hindered settling wherein the higher density particles will start to settle faster than the lower density particles in the pulp. Both the higher and lower density particles will quickly reach terminal velocity, at which point the higher and lower density particles will continue to settle at similar rates.

The downstroke of the sluice is arrested abruptly by the bottoming block 42, causing rapid deceleration of the sluice. Preferably, the bottoming block is positioned to arrest the downstroke substantially at the mid point of the sinusoidal wave, where the stroke velocity is highest and thus deceleration is greatest, but the position of the bottoming block may be adjustable to suit the particulate system being processed. Similarly, the cam is at its maximum upwards velocity at the point at which the cam again comes into contact with the sluice, so that upwards acceleration of the sluice at the commencement of the upstroke is maximised.

The rapid acceleration of the sluice at the end of the downstroke and at commencement of the upstroke cause differential acceleration of particles in the pulp bed as the lower density particles having a greater surface area per mass, will accelerate away with the elutriation fluid, causing consolidation of the high mass particles.

Again, the particles reach terminal velocity relatively quickly, with little further stratification achieved once terminal velocity is reached, so it is desirable for efficient operation of the apparatus for the particles to spend as great a proportion of the time as feasible under acceleration rather than at terminal velocity. To achieve this, the frequency of pulsation should be as high as feasible without causing cavitation. It is believed that high stroke frequencies may be able to be achieved using the gravity sluice arrangements of FIGS. 1 to 6 at atmospheric pressure, and that further increased frequencies may be possible by pressurising the space above the pulp in the sluice channel. In an unillustrated embodiment, such pressurisation may be achieved by introducing the elutriation fluid under pressure and sealing the top of the sluice channel, relying on the pressure drops across restricted discharge outlets to keep the sluice channel at positive pressure.

The combination of pulsation and the elutriation thus causes classification of the pulp by alternate hindered settling and differential acceleration of the particles, whilst employing a truncated vibratory mode increases the ratio of the time the particles are undergoing differential acceleration to that spent at terminal velocity.

In a further unillustrated embodiment, the elutriation of the bed may itself be pulsed, by employing a variable volume elutriation chamber formed between a fixed bottom plate and the moving floor of the sluice channel with flexible seals about their periphery. On the upstroke of the sluice chamber pulsation, the elutriation chamber fills with elutriation fluid, while on the downstroke the fluid is ejected into the sluice channel.

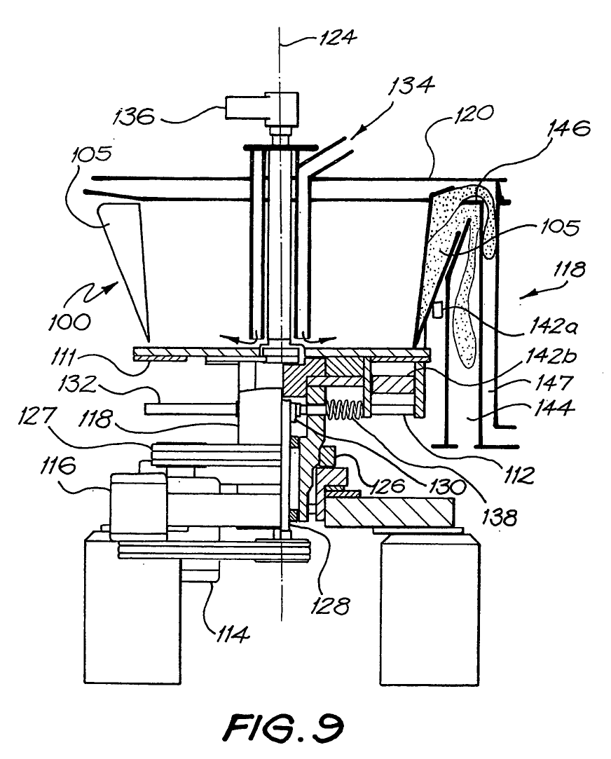

FIG. 8 illustrates a centrifugal version of the sluice, in which the sluice is mounted for high speed rotation about a rotational axis 66 and the settling force is the apparent centrifugal force 68 on the pulp rather than gravity.

The principles of construction and operation of the centrifugal sluice are similar to those discussed above with reference to FIG. 1 to 6, except that the sluice channels and reciprocating drive are reoriented to take into account the fact that the settling force acts substantially radially outwards rather than down. Hence, a plurality of similar sluice channels are arranged in a balanced circumferential array (only one is shown), each with an inlet end 70 which is circumferentially wide but radially shallow and a discharge end 72 which is radially deep but circumferentially narrow.

The pulp feed 74 and elutriation fluid feed 76 are distributed to the individual sluice compartments 78, and reciprocation of the compartments pivoting about pivot point 96 and driven via a central crank 80 and pushrod 82 arrangement. The compartments are biased radially outwards against the crank by means of a strong tension spring 84, and the radially inwards travel is limited by bottoming block 86 analogously to the gravity sluices discussed above.

As the sluice compartments are rotated and radially reciprocated, the particles in the feed pulp are separated into a heavies fraction, which exits the discharge end 72 of the compartment via a heavies spigot 88 into heavies launder 90. The light fraction passes radially inwards of a weir 92 into a light fraction launder 94.

By rapid rotation of the centrifugal sluice, the particles are subjected to a high apparent centrifugal force and separation of the particles will be enhanced. Furthermore, it is expected that it will be possible to reciprocate the centrifugal sluice at higher frequencies than the gravity sluice, for example about 50 Hz or more, before cavitation takes place, to further enhance separation.

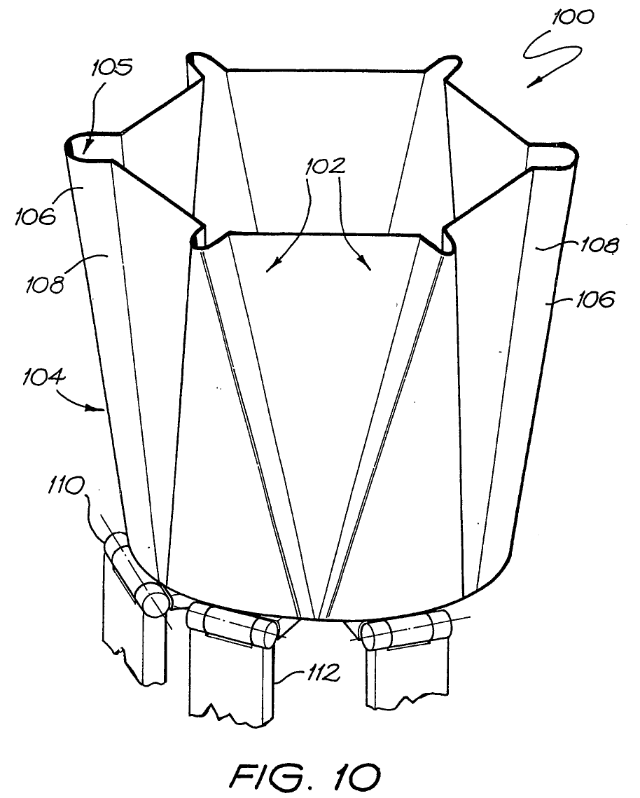

FIGS. 9 and 10 illustrate a further embodiment of a centrifugal sluice. FIG. 9 is a vertical section through the centrifugal sluice, and FIG. 10 is a schematic perspective of the bowl of the sluice.

With reference to FIG. 10, a sluice bowl 100 is formed by a circumferential array of bowl segments 102, which may be formed of cast metal or other suitable strong, rigid material. Each bowl segment 102 has a bowl wall portion 104 which is shaped to form a sluice channel 105 with a floor 106 and side walls 108 which converge from an inlet (bottom) end to a discharge (top) end while the sluice channel becomes deeper.

The bowl liner, of polyurethane or other suitable elastomeric material, conforms to the inside surface of the bowl segments.

The floor portion 106 of each sluice channel is perforated to provide for elutriation. Suitable means may include a double walled floor portion, generally as shown in FIG. 8, or alternatively a porous or perforated ceramic or other material insert on the inside surface of the liner, or by forming the floor portions of the liner of porous material capable of transmitting the elutriation fluid.

The bottom part of each bowl segment 102 has a pivot 110 and lever 112 arrangement.

With reference to FIG. 9, the bowl 100 is mounted via the pivots 110 to a base 111 adapted to fit to drive and feed arrangements similar to those used for the centrifugal jig disclosed in International Patent Application WO 99/08795.

The sluice arrangement has a frame supporting a bowl drive motor 114, a crank drive motor 116, a fixed launder arrangement 118 and cover 120 and a bowl main shaft 122 which is supported in bearings to rotate about a rotational axis 124.

The main shaft is driven by the bowl drive motor through bowl drive pulley 126 and bowl drive belt 127. Mounted inside the bowl main shaft for independent rotation in bearings is a crankshaft 128 with crank 130 for reciprocating a respective pushrod 132 for each bowl segment.

The feed particle mixture is fed via feed tube 134 to the base of the rotating container and moves out by centrifugal action to the wide, shallow inlet end of the sluice channels 105. Elutriation fluid, typically water, is fed via water inlet 136 and passes outwards through apertures in the base 111 to communicate with the elutriation means in the floor of each sluice channel.

Each bowl segment 102 has a respective pushrod 138 acting on its lever 112. The crank 130 sequentially reciprocates the pushrods 138 which are spring-biased to maintain contact with a cam follower on the crank 130.

Rotation of the bowl 100 biases each bowl segment and its respective sluice channel radially outwards, limited by one or more limiting rings 142a and 142b which limit outwards travel of the bowl segment 102 and/or inwards travel of the lever 112. The limiting rings 142a, 142b fulfil a similar purpose to the bottoming blocks of the previously described embodiments, i.e. truncating reciprocation of the bowl segments.

Thus, during one half of the reciprocation cycle, the lever 112 will be pushed outwards by its pushrod 138, causing reciprocation of the respective bowl segment. During the remainder of the cycle, the reciprocation of the bowl segment is truncated by the limiting rings and the lever is spaced from the pushrod.

Classification of the particles in the bed occurs as described above, with the heavy fraction being collected by heavies launder 144, and the light fraction flowing inwards of a weir 146 to a light fraction launder 147.

As reciprocation of the bowl segments occurs sequentially about the bowl circumference, each bowl segment is only slightly advanced or retarded in its reciprocation sequence compared to the neighbouring segments, thus limiting the physical demands on the bowl liner at the junctions of adjacent bowl segments.

In a modification of the centrifugal sluice drive mechanism of FIG. 9, the crank 130 may be fixed, rather than driven, resulting in each bowl segment being reciprocated once per rotation of the bowl.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises where they appear.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, the scope of the invention being indicated by the appended claims rather than the foregoing description, and all changes which come within the meaning and range of equivalency of the claims are therefore intended to be embraced therein. It will further be understood that any reference herein to known prior art does not, unless the contrary indication appears, constitute an admission that such prior art is commonly known by those skilled in the art to which the invention relates.

1. Apparatus for classification of a feed particle mixture into two or more fractions by differential acceleration and settling under influence of a settling force, including
a pinched sluice having a sluice channel which changes in transverse cross sectional shape from a feed inlet end which is shallow in a direction parallel to the settling force and wide in a direction perpendicular to the settling force to a discharge end which is deeper and more narrow than the feed inlet end,
feed apparatus for distributing the feed mixture to the feed inlet end as a shallow bed, said bed increasing in depth as the bed travels through the sluice channel from said inlet end to said discharge end,
discharge apparatus for discharge of said two or more fractions from said deeper bed at said discharge end,
elutriation means for inducing a flow of elutriation fluid through the bed in a substantially direction opposite to the settling force as the bed travels through the sluice channel from said inlet end to said discharge end,
a reciprocating drive for inducing alternating up and down acceleration of the sluice channel relative to the settling force,
such that said alternating acceleration and elutriation together induce classification of said particle mixture by alternating acceleration and hindered settling of particles in the bed.

2. Classification apparatus according to claim 1 wherein said sluice channel is formed by at least a floor and a pair of opposed side walls and wherein said elutriation means includes a plurality of elutriating fluid inlets in said floor of the sluice channel.

3. Classification apparatus according to claim 2 wherein said elutriation fluid inlets communicate with a pressurised elutriation fluid chamber below said floor.

4. Classification apparatus according to claim 3 wherein said elutriation fluid chamber is divided into two or more zones, and wherein a first said zone providing elutriation fluid to a thick bed of material adjacent the discharge end of the sluice has greater elutriation fluid pressure than a second said zone providing elutriation fluid to a thinner bed of material adjacent the inlet end of the sluice.

5. Classification apparatus according to claim 1 wherein said sluice channel has a floor which slopes at a downwards angle relative to the settling force from the feed inlet end to the discharge end.

6. Classification apparatus according to claim 5 wherein said sluice channel has a pair of opposed side walls converges from the feed inlet end to the discharge end.

7. Classification apparatus according to claim 6 wherein said downwards angle of the floor and an angle of convergence of said pair of opposed side walls result in an approximately constant cross-sectional area along the sluice channel.

8. Classification apparatus according to claim 1 wherein said reciprocating drive is adapted to produce an amplitude of reciprocation of the sluice channel which increases from said inlet end to said discharge end.

9. Classification apparatus according to claim 8 wherein the amplitude of reciprocation of the sluice channel increases substantially proportionally with the depth of the bed.

10. Classification apparatus according to claim 9 wherein reciprocation of said sluice channel is pivoted about a pivot point adjacent the inlet end.

11. Classification apparatus according to claim 10 wherein said discharge end of the sluice is biased against a reciprocation cam.

12. Classification apparatus according to claim 1 wherein said reciprocating drive induces a bottom-truncated reciprocation of the sluice channel.

13. Classification apparatus according to claim 12 wherein said reciprocating drive induces a bottom-truncated sine wave reciprocation of the sluice channel.

14. Classification apparatus according to claim 12 wherein said bottom-truncated reciprocation is truncated to arrest downstroke of the sluice channel at a point of substantially maximum downwards velocity.

15. Classification apparatus according to claim 14 wherein said bottom-truncated reciprocation comprises a downstroke inducing said differential hindered settling and a truncation and upstroke inducing said differential acceleration.

16. Classification apparatus according to claim 1 wherein said settling force is gravity.

17. Classification apparatus according to claim 1 wherein said sluice channel is mounted for rotation about a rotational axis such that said settling force is an apparent centrifugal force on the particles within the bed.

18. Classification apparatus according to claim 17 wherein a floor of the sluice channel is an outer circumferential wall of the sluice channel and the reciprocating drive causes alternating radially outwards and radially inwards acceleration of the sluice channel.

19. Classification apparatus according to claim 1 wherein said classification apparatus is one of a plurality of similar apparatuses and wherein said reciprocating drive includes a central drive in common to the reciprocating drives of said apparatuses.

20. Classification apparatus according to claim 19 wherein said apparatuses are arranged about said central drive.

21. Classification apparatus according to claim 20 wherein said settling force is gravity.

22. Classification apparatus according to claim 20 wherein the sluice channels of said apparatuses are mounted for rotation about a common rotational axis such that said settling force is an apparent centrifugal force on the particles within the bed.

23. Classification apparatus according to claim 22 wherein the apparatuses are arranged in a balanced circumferential array.

24. Classification apparatus according to claim 22 wherein a floor of the sluice channel is an outer circumferential wall of the sluice channel and the reciprocating drive causes alternating radially outwards and radially inwards acceleration of the sluice channel

25. Classification apparatus according to claim 1 wherein said discharge apparatus includes an adjustable splitter for adjusting separation between said two or more fractions.

26. Classification apparatus according to claim 25 wherein said adjustable splitter comprises a height-adjustable weir.

27. A method for classification of a feed particle mixture into two or more fractions by differential acceleration and settling under influence of a settling force, including
providing a pinched sluice having a sluice channel which changes in transverse cross sectional shape from a feed inlet end which is shallow in a direction parallel to the settling force and wide in a direction perpendicular to the settling force to a discharge end which is deeper and more narrow than the feed inlet end,
distributing the feed mixture to the feed inlet end as a shallow bed and causing said bed to travel through the sluice channel from said inlet end to said discharge end, said bed increasing in depth from said inlet end to said discharge end,
discharging said two or more fractions from said deeper bed at said discharge end,
elutriating the bed by inducing a flow of elutriation fluid through the bed in a substantially direction opposite to the settling force as the bed travels through the sluice channel from said inlet end to said discharge end, and
reciprocating the bed by inducing alternating up and down acceleration of the sluice channel relative to the settling force,
such that said alternating acceleration and elutriation together induce classification of said particle mixture by alternating acceleration and hindered settling of particles in the bed.

28. A method according to claim 27 wherein said elutriation step includes introducing said elutriation fluid into said bed through a plurality of elutriating fluid inlets in a floor of the sluice channel.

29. A method according to claim 27 wherein said reciprocation step comprises reciprocating said the sluice channel at an amplitude which increases from said inlet end to said discharge end.

30. A method according to claim 29 wherein the amplitude of reciprocation of the sluice channel increases substantially proportionally with the depth of the bed.

31. A method according to claim 29 wherein reciprocation of said sluice channel is pivoted about a pivot point adjacent the inlet end.

32. A method according to claim 27 wherein said reciprocating step comprises inducing a bottom-truncated reciprocation of the sluice channel.

33. A method according to claim 32 wherein said reciprocating step comprises inducing a bottom-truncated sine wave reciprocation of the sluice channel.

34. A method according to claim 32 wherein truncation of said reciprocation includes the step of arresting downstroke of the sluice channel at a point of substantially maximum downwards velocity.

35. A method according to claim 32 wherein said bottom-truncated reciprocation comprises a downstroke inducing said differential hindered settling and a truncation and upstroke inducing said differential acceleration.

36. A method according to claim 27 including rotating said sluice channel about a rotational axis such that said settling force is an apparent centrifugal force on the particles within the bed.

37. A method according to claim 36 including rotating a plurality of said sluice channels about said rotational axis.

38. A method according to claim 37 wherein said plurality of sluice channels is arranged in a balanced circumferential array.
